(19) United States
(12) Patent Application Publication
(10) Pub. No.: US 2005/0031026 A1
(43) Pub. Date: Feb. 10, 2005

(54) Hybrid computer modem

(76) Inventors: Huaiyu Zeng, Red Bank, NJ (US); Jimmy C. Tran, Jackson, NJ (US); Ashutosh Dixit, Scotch Plains, NJ (US); Xiao-Feng Qi, Freehold, NJ (US)

Correspondence Address: Kenneth J. Cool;BLAKELY SOKOLOFF TAYLOR & ZAFMAN LLP, 12400 Wilshire Boulevard 7th Floor, Los Angeles, CA, 90025, US

(21) Appl. No.: 10/635,526

(22) Filed: Aug. 7, 2003

(51) Int. Cl. H04B 1/38

(52) U.S. Cl. 375/222

(57) ABSTRACT

Methods and systems provide for operating a modem system having a transmit functionality and a receive functionality. The transmit functionality is implemented in hardware and portions of the receive functionality are implemented in software. In one approach, the receive functionality is partitioned between the software and the hardware based on a resource budget of a computer associated with the modem system.

### CROSS-REFERENCE TO RELATED APPLICATIONS

The present application is related to the patent application entitled “Re-Configurable Decoding in Modem Receivers” by Xie, Q. et al., filed on even date herewith.

### BACKGROUND

1. Technical Field

The Embodiments of the present invention are directed to data communication. More particularly, embodiments of the present invention are directed to data communication using a computer modem.

2. Discussion

The Internet is frequently being accessed in homes and businesses over high-speed communication networks. The broadband access technologies associated with these networks include digital subscriber lines (“DSL”), cable networks and wireless local area networks (“WLAN”). Most high-speed communication networks are implemented with a pair of modems—one at the central office (“CO”) where the Internet data is sourced, and one at the customer premise equipment (“CPE”) where the Internet data is delivered.

Most modems at the CPE for high speed networks are hardware based (“hard modem”), so that the physical layer (“PHY”) is typically implemented with digital signal processors (“DSP”s) and Application Specific Integrated Circuits (“ASIC”s). It is often difficult to support multiple line codes with a hardware-based modem, however, due to the high cost and the long development cycle.

Other modems at the CPE are software based (“soft modem”), so that the main processor on a personal computer executes the PHY function. Soft modems have been successfully deployed in the voice band modem market where required speeds typically are only 56k. Soft modems have advantages over hard modems such as low cost and ease of progammability. For high-speed networks, however, soft modems have at least two disadvantages.

For one, soft modems are usually several generations behind hard modems due to computer resource limitations. Since the typical computer running the Windows operating system from Microsoft Corp. is a non real-time open system, there are recommendations on resource allocations for real-time processes. For example, the interrupt cycles should be in the range of 3 to 16 ms. The soft modem interrupt service routine (“ISR”) should not disable interrupts for more than 100 us. If deferred procedure call (“DPC”) is used, 500 us is recommended (i.e., 17% of the processor usage) for a 3 ms interrupt. If a soft modem does not adhere to these rules, the modem will be unstable while operating certain applications. Using these parameters, on a computer having a 2 GHz processor, only 340 MIPS of the processor is available for the soft modem. This is not enough processing power for the typical high-speed modem.

Soft modems are also not applicable to low latency communication systems. The interrupt cycle of a computer is relatively long for some low latency systems such as WLAN and cable Internet access systems. In the cases of WLAN and cable systems, where the communication physical media is shared by multiple users, the CPE modem needs to quickly acknowledge when it successfully receives a packet. However, the soft modem is not suitable for such a low latency requirement.

Based on the foregoing, there is a need for an improved CPE modem for high-speed communication networks.

### BRIEF DESCRIPTION OF THE DRAWINGS

The various advantages of the embodiments of the present invention will become apparent to one skilled in the art by reading the following specification and appended claims, and by referencing the following drawings, in which:

FIGS. 1A, 1B and 1C are block diagrams of an example of a conventional hard modem architecture, a conventional soft modem architecture, and a soft receiver architecture according to one embodiment of the invention, respectively; and

FIG. 2 is a block diagram of an example a hybrid modem system according to one embodiment of the invention.

### DETAILED DESCRIPTION

One embodiment of the present invention is a hybrid modem or “soft receiver” modem in which the modem functionality is split between hardware and software portions. In one embodiment, portions of the receive functionality are partitioned between a host computer and a hardware datapump to meet the computer resource budget, while transmit functions (or “operations”) and some low latency receive functions such as a control channel are implemented with hardware to meet low latency requirements and to tolerate operating system latency.

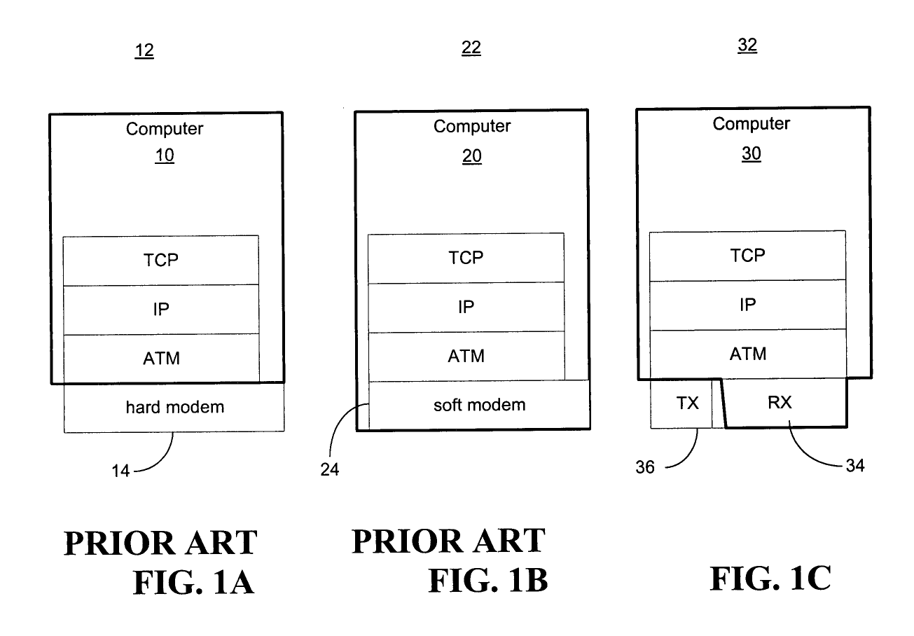

FIGS. 1A-1C illustrate how the function of one embodiment of the present invention and conventional modems is partitioned between hardware and software on a computer. Conventional hard modem architecture 12 includes a computer 10 and a modem 14. The computer 10 executes software on a processor (not shown) to implement Transmission Control Protocol (“TCP”), Internet Protocol (“IP”) and Asynchronous Transfer Mode (“ATM”) functionality. The modem functionality is implemented on hardware 14. Conventional soft modem architecture 22 includes a computer 20 that implements in software TCP, IP and ATM functionality as well as portions of the modem 24 functionality. Soft receiver architecture 32, in accordance with one embodiment of the present invention, includes a computer 30 that implements in software TCP, IP and ATM functionality as well as portions of the receive functionality 34 of the modem. Meanwhile, the transmission functionality 36 is implemented in hardware.

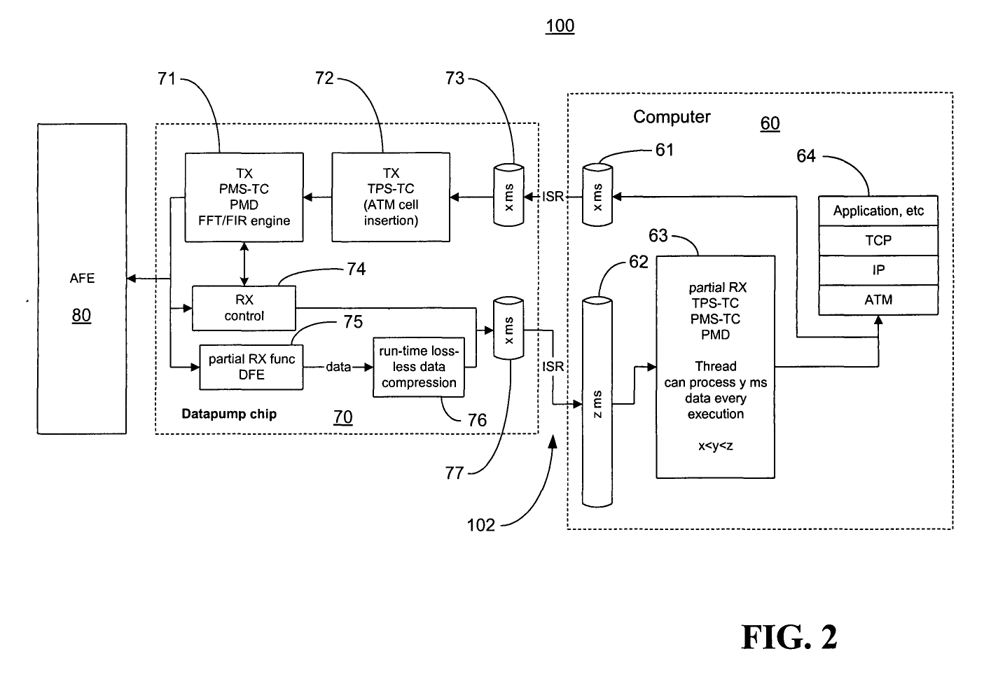

FIG. 2 is a block diagram of a hybrid modem system 100 in accordance with one embodiment of the present invention. In the illustrated modem system 100 is a CPE modem system that is in communication with a CO modem (not shown), where the CO modem provides access to the Internet. Modem system 100 is illustrated as being an asymmetric DSL (“ADSL”) modem, although other types of modems can also benefit from the principles described herein. Other modem examples include, but are not limited to, ADSL 2+ (International Telecommunications Union/ITU G.992.5) and wireless local area network/WLAN 802.11x (Institute of Electrical and Electronics Engineers/IEEE) compliant modems.

Modem system 100 includes a computer 60 that includes a processor (not shown). In one embodiment, the processor is the Pentium 4 processor from Intel Corp. operating at 2 GHz and executing the Windows operating system. Computer 60 further includes a storage device (not shown) for storing software instructions. The storage device can be any commercially available machine readable medium such as read-only memory (ROM), compact disk ROM (CD ROM), random access memory (RAM), electronically erasable programmable ROM (EEPROM), etc.

Modem system 100 further includes a datapump 70. Datapump 70 is used to implement a hardware portion of the modem. Modem system 100 further includes an Analog Front End (“AFE”) 80 that includes analog-to-digital and digital-to-analog converters, and filters, for converting data received from the CO and data destined to be transmitted to the CO.

In the transmit direction, data is generated by a software stack 64 that includes the application that is generating the data (e.g., a web browser), an ADSL application for processing data, and a TCP, IP and ATM layer. The outgoing data is stored in a transmit buffer 61 of the computer 60. In response to an ISR from datapump 70, the data is transferred to a transmit buffer 73 of the datapump 70. Buffer 73 and buffer 61 can be approximately the same size. In one embodiment “x” of buffers 73 and 61 is four. In one embodiment, the interface 102 between datapump 70 and computer 60 is a Peripheral Component Interconnect (“PCI”) bus.

Datapump 70 further includes a Transmit Protocol Specific Transmission Convergence (“TPS-TC”) layer module 72 and a media module 71 that provides a Physical Media Specific Transmission Convergence (“PMS-TC”) layer, a Physical Media Dependent (“PMD”) layer, and a Fast Fourier Transform/Finite Impulse Response (FFT/FIR) engine or other digital filter.

Datapump 70 implements the majority of the transmit PHY of modem system 100. The transmit PHY is implemented on hardware to preserve the upstream link quality for the CO. The ISR latency due to the unpredictability of the non-real-time Windows operating system can be handled by datapump 70. To prevent link drop and a high bit error rate (“BER”), idle ATM cells are inserted by TPS-TC layer 72 whenever it detects the transmit buffer starving. Similarly if Ethernet is used, byte insertion in High-level Data Link Control (“HDLC”) framing causes rate decoupling.

In the receive direction, data received from AFE 80 is sent to an RX control module 74 that synchronizes clocking, and to a digital front end (“DFE”) 75 that provides functions such as digital filtering, decimation, and rate conversions. The digital data can then be compressed by a data compression module 76 and stored in a receive buffer 77 of datapump 70. If the interface 102 has sufficient bandwidth, module 76 may not be needed. On the other hand, module 76 enables a reduction in the size of buffers 77,62.

In response to an ISR, the data is transferred to a receiver buffer 62 in computer 60. The data transfer is handled by an ISR at the desired transfer rate, or every x ms as illustrated. In one embodiment, buffer 62 is larger than buffer 77 because the processor of computer 60 cannot at all times process data as quickly as the data is received from AFE 80.

At block 63, the RX PHY and ADSL software processes the data in buffer 62 as a thread triggered by the ISR. In each execution, the RX PHY can process data at the desired processing rate, or every y ms as illustrated, where the processing rate is faster than the transfer rate (i.e., y>x). Therefore, the RX PHY runs faster than the incoming data. When the RX PHY thread is disrupted and delayed by other computer applications, the next RX PHY process can catch up with the incoming data.

In one embodiment, the interrupt period (i.e., x) is set to a similar value that is used in conventional hard modems so that the ISR drop probability is similar for both the conventional hard modem and modem system 100. The transferred data is properly time-stamped. In the case of an ISR miss, the system synchronization can be kept from the time stamp.

To deal with thread latency, buffer 62 is large compared to buffer 77 in one embodiment. If RX buffer 62 overflows, one approach is to drop data but keep the link in synch. As a result, the down stream end-to-end throughput may be reduced. It should be noted that dropped data can be requested again so that the only sacrifice is throughput.

In one embodiment, some receive functions requiring fast responses are processed in the hardware of modem system 100. For example, in WLAN 802.11x, automatic gain control (AGC) and phase synchronization is implemented during the preamble because they require relatively fast responses. Computer 60 may not be suitable for this type of processing due to the potential for a large latency between computer 60 and datapump 70. However such control functions usually require low million instructions per second (MIPS). Thus the hardware cost compared to the payload data processing is usually insignificant.

In one embodiment, data compression module 76 is included because many high-speed modems require a large PCI bandwidth. For example, with Very High Speed DSL (“VDSL”), the received data are sampled at 17 MHz with 16 bits per sample, or 34 MB/s. Data compression module 76 is therefore used to reduce the bandwidth requirement. In particular, a run-time loss-less compression algorithm is used to compress the raw data. For a given buffer size, the period of the data block (x) varies depending on the compression ratio. On average, the required bandwidth is reduced. This option also allows for a smaller buffer to be included in datapump 70. The smaller buffer in turn lowers the cost of modem system 100.

In some embodiments, the amount of resources available on computer 60 determines what RX functions are implemented on datapump 70. For example, receive digital front-end functions such as decimation and rate conversion are high MIPS fixed-operation functions and may be implemented in hardware to reduce the MIPS requirement from computer 60. The guideline is to implement non-adaptation and commonly used functions in hardware, and move as much adaptation blocks to the host as possible, to achieve high programmability.

Several embodiments of the present invention are specifically illustrated and/or described herein. However, it will be appreciated that modifications and variations of the embodiments of the present invention are covered by the above teachings and within the purview of the appended claims without departing from the spirit and intended scope of the embodiments of the present invention. For example, the ITU-specific PHY sublayers have been provided merely to facilitate a better understanding of the embodiments. Thus, sublayer terminologies from other standardizations can be readily substituted for the discussed sublayers. For example, the Physical Coding Sublayer (PCS) and Physical Medium Attachment (PMA) layers associated with IEEE WLAN 802.11x modems can be readily implemented instead of the ITU-T based TPS-TC and PMS-TC layers respectively.

1. A method of operating a modem system having a transmit functionality and a receive functionality, comprising:
implementing the transmit functionality in hardware; and
implementing one or more portions of the receive functionality in software.

2. The method of claim 1, wherein the receive functionality is partitioned between the software and the hardware.

3. The method of claim 2, further including implementing a physical layer (PHY) of the receive functionality in the software.

4. The method of claim 3, further including:
storing incoming data to a computer receive buffer; and
processing stored incoming data, the processing being conducted at a faster rate than the storing is conducted.

5. The method of claim 4, further including receiving the incoming data from a datapump receive buffer, the computer receive buffer being larger than the datapump receive buffer.

6. The method of claim 3, further including implementing a Transmit Protocol Specific Transmission Convergence layer of the receive functionality in the software.

7. The method of claim 3, further including implementing a Physical Media Specific Transmission Convergence layer of the receive functionality in the software.

8. The method of claim 3, further including implementing a Physical Media Dependent layer of the receive functionality in the software.

9. The method of claim 2, further including implementing control channel portions of the receive functionality in the hardware.

10. The method of claim 9, further including conducting clocking synchronization with the hardware.

11. The method of claim 2, further including:
implementing a digital front end portion of the receive functionality in the hardware; and
implementing a data compression portion of the receive functionality in the hardware.

12. The method of claim 2, wherein the receive functionality is partitioned based on a resource budget of a computer associated with the modem system.

13. The method of claim 1, further including implementing a physical layer (PHY) of the transmit functionality in the hardware.

14. The method of claim 13, further including:
implementing a Transmit Protocol Specific Transmission Convergence layer of the transmit functionality in the hardware;
implementing a digital filter of the transmit functionality in the hardware;
implementing a Physical Media Specific Transmission Convergence layer of the transmit functionality in the hardware; and
implementing a Physical Media Dependent layer of the transmit functionality in the hardware.

15. The method of claim 14, further including inserting idle cells into outgoing data in response to detecting transmit buffer starving.

16. A modem system comprising:
a datapump, the datapump to implement a transmit functionality of the modem system; and
a computer coupled to the datapump, the computer including software to implement one or more portions of a receive functionality of the modem system.

17. The modem system of claim 16, wherein the receive functionality is partitioned between the software and the datapump.

18. The modem system of claim 17, wherein the software includes instructions to implement a physical layer (PHY) of the receive functionality.

19. The modem system of claim 18, wherein the computer further includes a computer receive buffer, the software including instructions to store incoming data to the computer receive buffer and process stored incoming data, the processing to be conducted at a faster rate than the storing is conducted.

20. The modem system of claim 19, wherein the datapump further includes a datapump receive buffer, the computer receive buffer being larger than the datapump receive buffer.

21. The modem system of claim 18, wherein the software includes instructions to implement a Transmit Protocol Specific Transmission Convergence layer of the receive functionality.

22. The modem system of claim 18, wherein the software includes instructions to implement a Physical Media Specific Transmission Convergence layer of the receive functionality.

23. The modem system of claim 18, wherein the software includes instructions to implement a Physical Media Dependent layer of the receive functionality.

24. The modem system of claim 17, wherein the datapump includes:
a receive control module, the receive control module to implement control channel portions of the receive functionality;
a receive digital front end, the receive digital front end to implement digital filtering, decimation and rate conversion portions of the receive functionality; and
a data compression module, the data compression module to implement compression portions of the receive functionality.

25. The modem system of claim 16, wherein the datapump is to implement a physical layer of the transmit functionality, the datapump including:
a protocol module, the protocol module to implement a Transmit Protocol Specific Transmission Convergence layer of the transmit functionality; and
a media module, the media module to implement a Physical Media Specific Transmission Convergence layer, a Physical Media Dependent layer, and a digital filtering portion of the transmit functionality.

26. The modem system of claim 15, wherein the datapump includes a datapump transmit buffer and the computer includes a computer transmit buffer, the transmit buffers to store outgoing data.

27. A modem architecture comprising:
an analog front end;
a datapump coupled to the analog front end, the datapump to implement a transmit functionality of a modem system, the datapump including a receive control module to implement control channel portions of the receive functionality, a receive digital front end to implement digital filtering, decimation and rate conversion portions of a receive functionality of the modem system, and a data compression module to implement compression portions of the receive functionality;
a bus coupled to the datapump; and
a computer coupled to the bus, the computer including software to implement portions of the receive functionality, the receive functionality being partitioned between the software and the datapump, the software including instructions to implement a physical layer of the receive functionality.

28. The modem architecture of claim 27, wherein the computer further includes a computer receive buffer coupled to the bus, the software including instructions to store incoming data to the computer receive buffer and process stored incoming data, the processing to be conducted at a faster rate than the storing is conducted.

29. The modem architecture of claim 28, wherein the datapump further includes a datapump receive buffer coupled to the bus, the computer receive buffer being larger than the datapump receive buffer.
